(19) United States
(12) Patent Application Publication
(10) Pub. No.: US 2019/0184904 A1
(43) Pub. Date: Jun. 20, 2019

(54) PICKUP TRUCK STORAGE BOX

(71) Applicant: Anhui Marretoo Auto Accessory Co., Ltd., Hefei (CN)

(72) Inventors: Huijun FANG, Hefei (CN); Hongyan NIE, Hefei (CN)

(73) Assignee: Anhui Marretoo Auto Accessory Co., Ltd., Hefei (CN)

(21) Appl. No.: 15/870,841

(22) Filed: Jan. 12, 2018

(30) Foreign Application Priority Data
Dec. 14, 2017 (CN) 201711338974.0

(51) Int. Cl. B60R 7/04; B60R 7/00; B65D 25/06

(52) U.S. Cl. CPC B60R 7/043; B65D 25/06; B60R 7/005

(57) ABSTRACT

The present invention provides a pickup truck storage box, including: a rectangular box body, an elastic net and a plurality of division plates. The box body includes a bottom plate, a front side plate, a back side plate, a left side plate and a right side plate. The left side plate, the front side plate, the right side plate and the back side plate are connected in sequence and form a storage space together with the bottom plate, and the box body is provided with a plurality of pairs of engaging slots along a length direction. The division plates are detachably inserted into the engaging slots, and the elastic net is hung at a position close to a side wall of the box body.

### CROSS-REFERENCE TO RELATED APPLICATIONS

This Non-provisional application claims priority under 35 U.S.C. § 119(a) on Patent Application No(s). 201711338974.0 filed in People's Republic of China on Dec. 14, 2017, the entire contents of which are hereby incorporated by reference.

### BACKGROUND OF THE INVENTION

### Field of the Invention

The present invention relates to a pickup truck field, and more particularly, to a pickup truck storage box.

### Description of the Related Art

The pickup truck is a kind of vehicle with a car head cab and with an open carriage at the same time. Relying on its beautiful appearance, car-like comfort, strong power, low price, as well as the practicability of capable of both carrying people and carrying goods, the pickup truck is welcomed by a plurality of consumers.

However, the pickup truck does not have a trunk. Therefore, there is no place to store articles in the vehicle, and many owners directly put the articles on rear seats and below the seats, which greatly affects cleanliness and beauty of the vehicle. This disadvantage affects promotion and use of the pickup truck. U.S. Pat. No. 6,824,029 B2 provides a storage box on the rear seat of the pickup truck. The middle of the storage box is provided with a path for spacing the storage space, and a division plate is arranged along a length direction of a box body. A design layout of engaging slots of the division plate is unreasonable which leads the storage space of the storage box is relatively small. In addition, small articles or round articles cannot be fixed. When the vehicle is driving at a high speed, the small articles placed in the storage box will roll and make noise.

### BRIEF SUMMARY OF THE INVENTION

The objective of the present invention is to solve above-mentioned problems, providing a pickup truck storage box and adjusting a layout of the engaging slot of the division plates, such that the storage space is larger. In addition, a structure fixing small articles is arranged for better storing small articles.

To achieve above-mentioned objective, the present invention provides a pickup truck storage box, including: a rectangular box body, an elastic net and a plurality of division plates. The box body includes a bottom plate, a front side plate, a back side plate, a left side plate and a right side plate. The left side plate, the front side plate, the right side plate and the back side plate are connected in sequence and form a storage space together with the bottom plate, and the box body is provided with a plurality of pairs of engaging slots along a length direction. The division plates are detachably inserted into the engaging slots, and the elastic net is hung at a position close to a side wall of the box body.

In one embodiment of the present invention, the division plates may be provided with depressions, and the depressions on a plurality of division plates may correspond to each other.

In one embodiment of the present invention, an upper edge of each division plate may be provided with a flexible cushion.

In one embodiment of the present invention, a material of each division plate may be polypropylene plastic, a material of the flexible cushion may be rubber, and the division plate and the flexible cushion may be integrally injection-molded.

In one embodiment of the present invention, each division plate may be provided with a hook, and the elastic net may be hung at the hook.

In one embodiment of the present invention, the hook may be formed by partially hollowing out the division plate.

In one embodiment of the present invention, a bottom surface of the bottom plate may be provided with a plurality of first strengthening ribs arranged in a crisscross pattern.

In one embodiment of the present invention, both the front side plate and the back side plate may be provided with a plurality of longitudinally arranged second strengthening ribs, and the back side plate may be provided with at least a horizontally arranged third strengthening rib. The third strengthening rib may be connected with a plurality of second strengthening ribs at the back side plate.

In one embodiment of the present invention, both the left side plate and the right side plate may be provided with arc protruding platforms.

In one embodiment of the present invention, the box body may be processed and formed by injection molding process.

Compared with the prior art, beneficial effects of the present technical solution are:

In the pickup truck storage box of the present invention, by arranging a plurality of pairs of engaging slots along the length direction of the box body, the division plates can be inserted into different engaging slots so as to adjust the storage space according to requirements, and the design is more reasonable, thereby obtaining a larger storage space. In addition, the elastic net is arranged to fix small articles and round articles which prevents the small articles or round articles from rolling when the pickup truck is driving at a high speed.

### BRIEF DESCRIPTION OF THE DRAWINGS

FIG. 1 is a perspective view of a pickup truck storage box according to one embodiment of the present invention;

FIG. 2 is a perspective view a box body of the pickup truck storage box according to one embodiment of the present invention;

FIG. 3 is another perspective view of the box body of the pickup truck storage box according to one embodiment of the present invention;

FIG. 4 is a side view of the box body of the pickup truck storage box according to one embodiment of the present invention;

FIG. 5 is a top view of the box body of the pickup truck storage box according to one embodiment of the present invention;

FIG. 6 is a structural schematic diagram of a division plate of the pickup truck storage box according to one embodiment of the present invention; and

FIG. 7 is a structural schematic diagram of a division plate of a pickup truck storage box according to another embodiment of the present invention.

### DETAILED DESCRIPTION OF THE INVENTION

A technical solution of the present invention will be clearly and completely described below with reference to the accompanying drawings through specific embodiments.

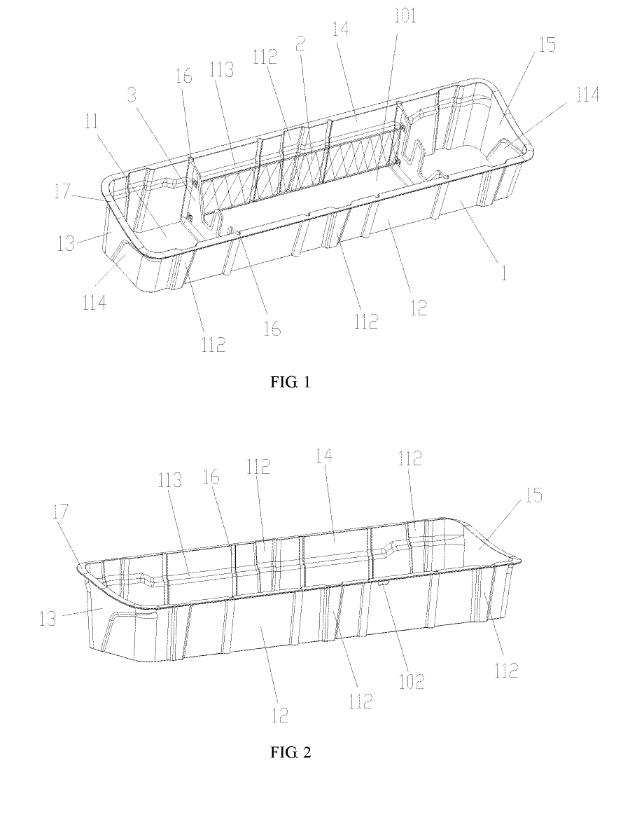

Please refer to FIG. 1 to FIG. 5. The present invention provides a pickup truck storage box, including: a rectangular box body 1, an elastic net 2 and a plurality of division plates 3. The box body 1 includes a bottom plate 11, a front side plate 12, a back side plate 14, a left side plate 13 and a right side plate 15. The left side plate 13, the front side plate 12, the right side plate 15 and the back side plate 14 are connected in sequence and form a storage space 101 together with the bottom plate 11. Articles can be stored in the storage space 101.

The box body 1 is provided with a plurality of pairs of engaging slots 16 along a length direction, and the division plates 3 are detachably inserted into the engaging slots 16. A user can insert the division plates 3 into the corresponding engaging slots 16 according to different sizes of the stored articles, thereby obtaining a larger storage space 101. In addition, when the stored articles are different, the user can change insertion positions of the division plates 3 at any time, which is very convenient.

The elastic net 2 is hung at a position close to a side wall of the box body 1. Small articles or round articles can be stored inside the elastic net 2. Due to an elastic effect of the elastic net 2, small articles or round articles can be well fixed in the box body 1, and small articles or round articles will not roll randomly when the pickup truck is driving at a high speed.

In the pickup truck storage box of the present invention, by arranging a plurality of pairs of engaging slots 16 along the length direction of the box body 1, the division plates 3 can be inserted into different engaging slots 16 so as to adjust the storage space 101 according to requirements, and the design is more reasonable, thereby obtaining a larger storage space 101. In addition, the elastic net 2 is arranged to be able to fix small articles and round articles, which avoids the rolling of the small articles or round articles when the pickup truck is driving at a high speed.

In one embodiment, the elastic net 2 is made of an elastic nylon material. The material is cheap, and the cost can be reduced. In addition, the elastic net 2 is a double-layer structure, which can fix small articles better.

In one embodiment, the box body 1 is provided with four pairs of engaging slots 16. The four pairs of engaging slots 16 are uniformly distributed along the length direction of the box body 1, that is, both the front side plate 12 and the back side plate 14 are provided with the engaging slots 16. The size of a plurality of pairs of engaging slots 16 are the same, and the engaging slots 16 are all suitable for cooperation with the division plates 3. In one embodiment, the number of the division plates 3 is two, and the two division plates 3 can be inserted into different engaging slots 16. Then the storage space 101 is divided into a plurality of small storage units, which facilitates the classification and storage of the articles. However, this invention does not limited to thereto. The number of the engaging slots 16 may also be three pairs or five pairs or other values, and the number of the division plates 3 may also be three or four or other values. The present invention does not limit the number of the engaging slots 16 and the number of the division plates 3.

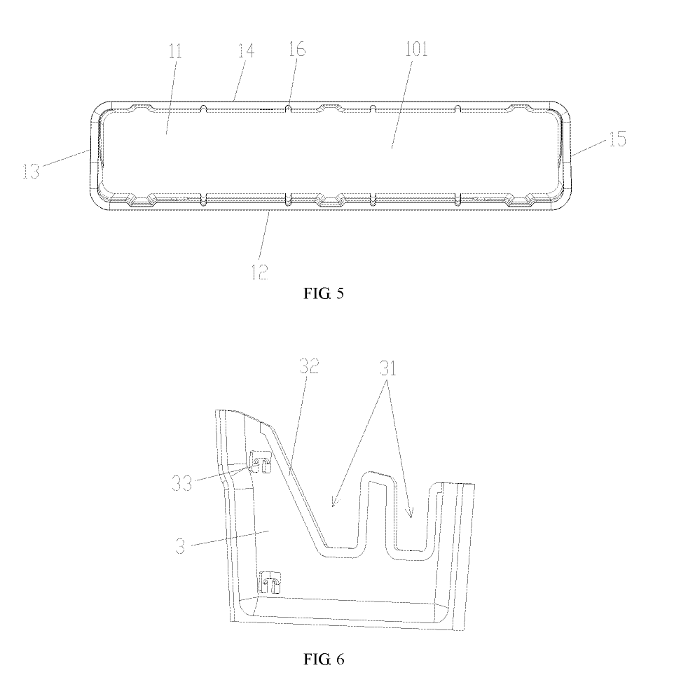

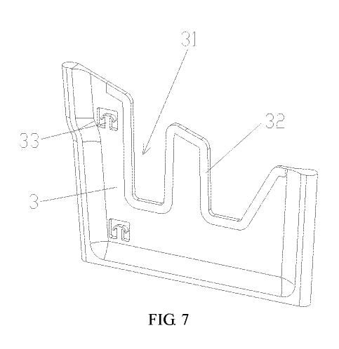

Please refer to FIG. 6 and FIG. 7. The division plates 3 are provided with depressions 31, and the depressions 31 on a plurality of division plates 3 correspond to each other. Strip-shaped articles, such as fishing rods, pool cues, battledores, tennis rackets and so on, can be placed on the depression 31. In one embodiment, each division plate 3 is provided with two depressions 31 which can better store the strip-shaped articles in different partitions. However, this invention does not limit to thereto. Each division plate 3 can be provided with one or three depressions 31, and the present invention does not limit thereto. The shape of the depression 31 can be a rectangle, or a trapezoid, or any other shape, and the present invention does not limit thereto.

An upper edge of the division plate 3 is provided with a flexible cushion 32. The flexible cushion 32 plays a very good role of cushioning to prevent articles placed thereon from being scratched.

In one embodiment, a material of the division plate 3 is polypropylene plastic, and a material of the flexible cushion 32 is rubber. The division plate 3 has a good strength and can play a role of blocking and supporting. The flexible cushion 32 has a very good cushioning effect, and the material is cheap. The division plate 3 and the flexible cushion 32 are integrally injection-molded which does not need further processing, and the processing technology is simple.

The division plate 3 is provided with hooks 33, and the elastic net 2 is hung at the hooks 33. It is very convenient to install and disassemble the elastic net 2. When the spacing of the division plate 3 is adjusted, the length of the elastic net 2 can be extended or shortened due to its own elastic force, and its applicability is very good.

In one embodiment, the hook 33 is formed by partially hollowing out the division plate 3. On one hand, the material is saved, and on the other hand, the hook 33 will not take up excess space. It is very convenient to use the hook 33.

Please refer to FIG. 2. The box body 1 is further provided with a mounting hole 102. The storage box is placed under the rear seat of the pickup truck, and the box body 1 can be fixed by using straps to pass through the mounting holes 102 to avoid moving of the box body 1 when the pickup truck is driving.

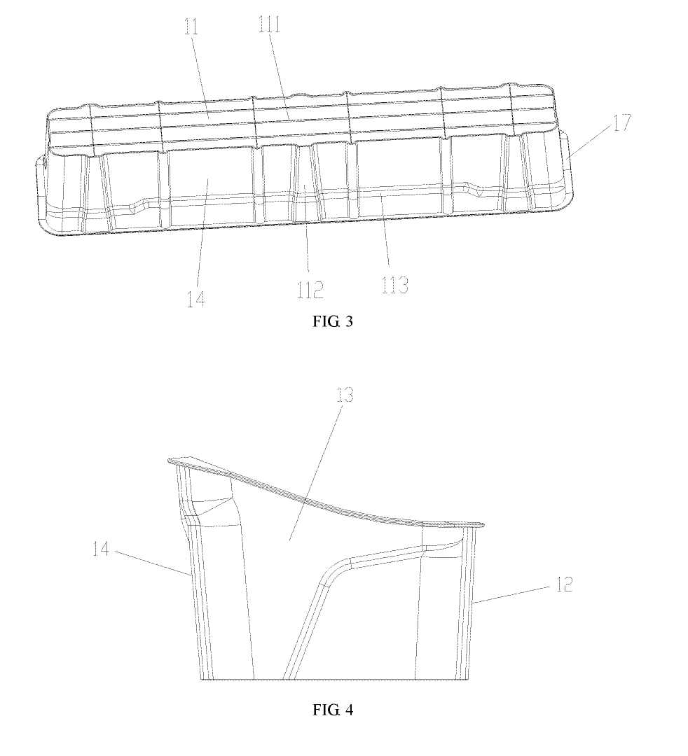

Please refer to FIG. 3. In one embodiment, a bottom surface of the bottom plate 11 is provided with a plurality of first strengthening ribs 111 arranged in a crisscross pattern. The first strengthening ribs 111 increase the friction between the box body 1 and the pickup car and improve the strength of the box body 1 at the same time. In addition, the upper edge of the box body 1 is provided with a turnup edge 17. The structure of the turnup edge 17 can prevent deformation of the box body 1 at the opening thereof, and the edge smoothly transits to avoid scratching the user.

Please refer to FIG. 1. Both the front side plate 12 and the back side plate 14 are provided with a plurality of longitudinally arranged second strengthening ribs 112, and the back side plate 14 is provided with at least a horizontally arranged third strengthening rib 113. The third strengthening rib 113 is connected with a plurality of second strengthening ribs 112 at the back side plate 14. Arranging the second strengthening ribs 112 and the third strengthening rib 113 can improve the strength of the front side plate 12 and the back side plate 14. In one embodiment, the second strengthening ribs 112 are trapezoidal ribs protruding outward. The structure is more stable, and the strength is higher.

In addition, please refer to FIG. 4, a height of the back side plate 14 is larger than a height of the front side plate 12 to facilitate pulling out the box body 1 from below the seat.

Please refer to FIG. 1. Both the left side plate 13 and the right side plate 15 are provided with arc protruding platforms 114, which can improve the strength of the left side plate 13 and the right side plate 15 of the box body 1 so as to make the structure of the box body 1 more stable.

In one embodiment, the box body 1 is processed and formed by injection molding process. The surface of the product made by the injection molding process is smooth and does not produce raw edge. Therefore, it does not need a secondary processing, the production process is simpler and the appearance is more beautiful.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A pickup truck storage box comprising: a rectangular box body, an elastic net and a plurality of division plates, and the box body comprising a bottom plate, a front side plate, a back side plate, a left side plate and a right side plate, wherein the left side plate, the front side plate, the right side plate and the back side plate are connected in sequence and form a storage space together with the bottom plate, the box body is provided with a plurality of pairs of engaging slots along a length direction, the division plates are detachably inserted into the engaging slots, and the elastic net is hung at a position close to a side wall of the box body.

2. The pickup truck storage box according to claim 1, wherein the division plates are provided with depressions, and the depressions on a plurality of division plates correspond to each other.

3. The pickup truck storage box according to claim 1, wherein an upper edge of each division plate is provided with a flexible cushion.

4. The pickup truck storage box according to claim 3, wherein a material of each division plate is polypropylene plastic, a material of the flexible cushion is rubber, and the division plate and the flexible cushion are integrally injection-molded.

5. The pickup truck storage box according to claim 1, wherein each division plate is provided with a hook, and the elastic net is hung at the hook.

6. The pickup truck storage box according to claim 5, wherein the hook is formed by partially hollowing out the division plate.

7. The pickup truck storage box according to claim 1, wherein a bottom surface of the bottom plate is provided with a plurality of first strengthening ribs arranged in a crisscross pattern.

8. The pickup truck storage box according to claim 1, wherein both the front side plate and the back side plate are provided with a plurality of longitudinally arranged second strengthening ribs, the back side plate is provided with at least a horizontally arranged third strengthening rib, and the third strengthening rib is connected with a plurality of second strengthening ribs at the back side plate.

9. The pickup truck storage box according to claim 1, wherein both the left side plate and the right side plate are provided with arc protruding platforms.

10. The pickup truck storage box according to claim 1, wherein the box body is processed and formed by injection molding process.
